(19) United States
(12) Patent Application Publication
(10) Pub. No.: US 2012/0303962 A1
(43) Pub. Date: Nov. 29, 2012

(54) SYSTEM AND METHOD FOR EMBEDDING A WRITTEN SIGNATURE INTO A SECURE ELECTRONIC DOCUMENT

(76) Inventors: Rod Ghani, Las Vegas, NV (US); Gene Squitieri, Las Vegas, NV (US)

(21) Appl. No.: 13/303,033

(22) Filed: Nov. 22, 2011

Related U.S. Application Data
(63) Continuation-in-part of application No. 11/687,592, filed on Mar. 16, 2007, now Pat. No. 8,065,527.

(51) Int. Cl. H04L 9/32; G06K 9/00

(52) U.S. Cl. 713/176

(57) ABSTRACT

A system and method for embedding a written signature into a secure electronic document is disclosed. The method includes forming a placeholder electronic document containing content to be attested to by a signature. A signing individual can be selected from a signer list. A signature tag can be placed into the placeholder electronic document at a selected signature location. The signature tag is associated with the signing individual and defines the signature location for the signing individual to sign. The placeholder electronic document can be secured to form a secure electronic document having content configured to be uneditable. A signature can be captured with a signature capture device configured to enable the signing individual to write the signature to be embedded into the secure electronic document at the location indicated by the signature tag to mimic a real world experience of signing paper documents.

### PRIORITY CLAIM

This application is a continuation-in-part of U.S. patent application Ser. No. 11/687,592 filed on Mar. 16, 2007 which is incorporated herein by reference.

### BACKGROUND

Signatures have been used for centuries to notarize and authenticate documents. A person's signature can give evidence of the provenance of a document as well as the intention of the person with regard to that document. For example, the role of a signature in many consumer contracts is not solely to provide evidence of the identity of the contracting party, but rather to additionally provide evidence of deliberation and informed consent. The unique properties of a person's signature have enabled their use as a legally binding indication that a signing individual, or signatory, understands and consents to documents containing their signature. Historically, signatures have also proven useful to thwart attempts at forgery. Even studious endeavors to write another's signature can often be detected by the trained eye.

With the advent of the digital age, a replacement for a person's handwritten signature has long been sought. However, despite the ability to transmit information over great distances with relative ease, an electronic substitute for the signature has been slow in coming. While many attempts have been made to create a digital equivalent for the signature, the written signature has proven difficult to replace. A comparable equivalent has not been found that includes a signatures unique ability to connect a person's intent and identity with the document upon which their signature is placed.

While there have been many attempts made by government, legal, and industry groups to create legally binding, digital equivalents to the written signature, many industries have been slow to adopt their efforts. The lack of an adequate replacement for the written signature has tended to reduce the amount of business and legal work that can be accomplished between remote locations.

### SUMMARY

A system and method for embedding a written signature into a secure electronic document is disclosed. The method includes forming a placeholder electronic document containing content to be attested to by a signature. A signing individual can be selected from a signer list. A signature tag can be placed into the placeholder electronic document at a selected signature location. The signature tag is associated with the signing individual and defines the signature location within the placeholder electronic document for the signing individual to sign. The placeholder electronic document can be secured to form a secure electronic document having content configured to be uneditable. A signature can be captured with a signature capture device configured to enable the signing individual to write the signature to be embedded into the secure electronic document at a location indicated by the signature tag to mimic a real world experience of signing paper documents.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1a is an illustration of an editing module configured to edit content in a placeholder electronic document, in accordance with an embodiment of the present invention;

FIG. 1b is an illustration of a user interface for entering a signer name and function in accordance with an embodiment of the present invention;

FIG. 1c is an illustration of a user interface for editing a signer name in accordance with an embodiment of the present invention;

FIG. 2 is an additional illustration of an editing module in accordance with an embodiment of the present invention;

FIG. 3 is an illustration of a secure document signer module in accordance with an embodiment of the present invention;

FIG. 4a is an illustration of a signature capture device displaying a signature capture bounding box in accordance with an embodiment of the present invention;

FIG. 4b is an illustration of a signature capture device displaying an initial capture bounding box in accordance with an embodiment of the present invention.

FIG. 4c is an illustration of a signature tag and an embedded signature in accordance with an embodiment of the present invention;

FIG. 4d is an illustration of a secure document signer module displaying an embedded signature in a secure electronic document in accordance with an embodiment of the present invention;

FIG. 4e is an illustration of a notary tag and an embedded signature with a notary stamp in accordance with an embodiment of the present invention;

FIG. 4f is an illustration of a secure document signer module displaying an embedded notary signature and notary stamp in the secure electronic document in accordance with an embodiment of the present invention;

FIG. 5 is an illustration of a system for embedding a written signature into a secure electronic document in accordance with an embodiment of the present invention;

FIG. 6 is a flow chart depicting a method for embedding a written signature into a secure electronic document in accordance with an embodiment of the present invention;

FIG. 7a is an illustration depicting various types of signature tags that can be inserted in the editing module in accordance with an embodiment of the present invention;

FIG. 7b is an illustration of a user interface for inserting a notary stamp in a notary tag in accordance with an embodiment of the present invention;

FIG. 8 is a flow chart depicting a method for transmitting an electronic document for embedding a written signature in accordance with an embodiment of the present invention; and

FIG. 9 is a flow chart depicting a method for receiving an electronic document for embedding a written signature in accordance with an embodiment of the present invention;

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

Despite the difficulty in finding a digital replacement for the written signature, there is still a great need to enable legal and business work to be conducted remotely. Obtaining written signatures is often an every day part of business and legal work. In accordance with one aspect of the invention, it has been recognized that a system and method is needed for embedding a written signature into a secure electronic document. Embedding a written signature into a secure electronic document in a digitized format can allow all of the unique benefits of a written signature to be retained, while enabling signed documents to be simply and easily electronically transmitted between remote locations.

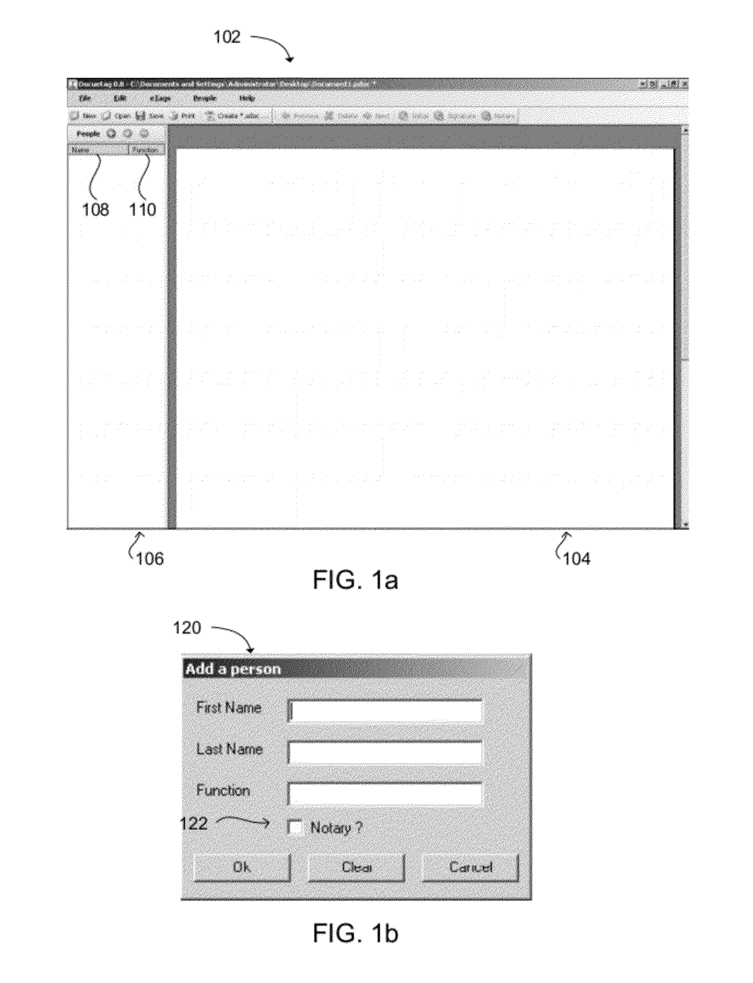

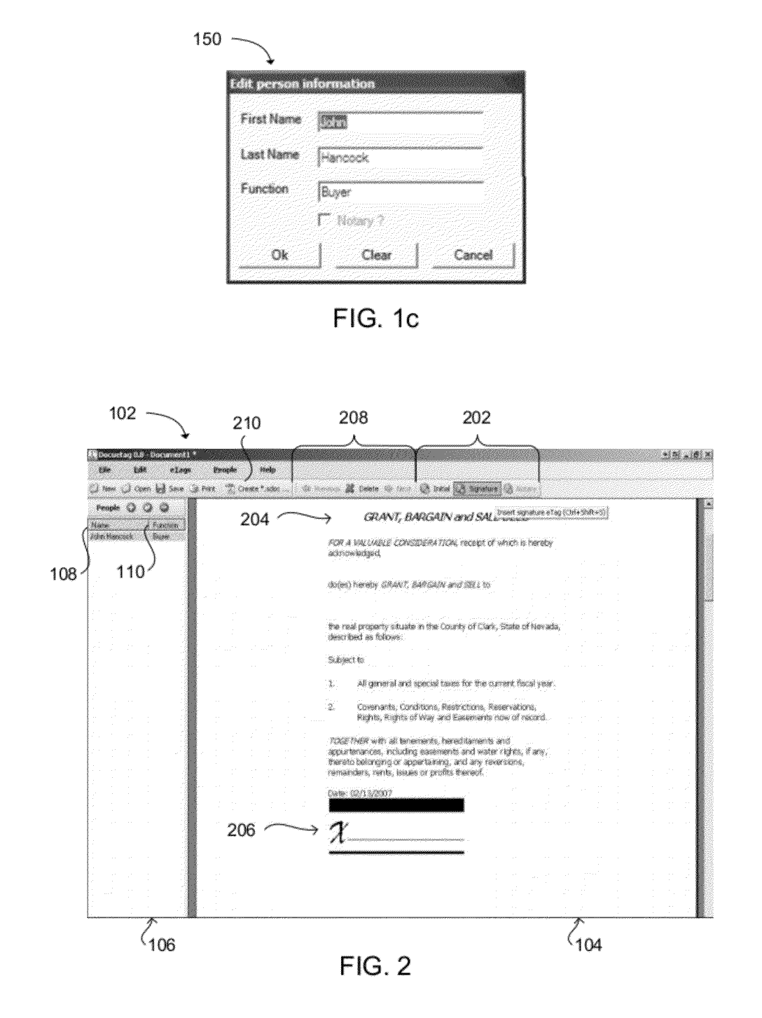

The system and method for embedding a written signature into a secure electronic document can include an editing module. FIG. 1a illustrates an editing module 102 configured to edit content in an electronic document. The editing module can include a text editing area 104. The electronic document formed using the editing module can be referred to as a placeholder electronic document. The editing module can be used to draft or edit content that is to be attested to by a signature. The editing module can also be used to import and edit documents in the text editing area that were created using other software, such as Microsoft Word, WordPerfect, OpenOffice, Google Docs, and the like.

A signer list module 106 can be included in or coupled to the editing module 102. As content is added in the text editing area 104, or after the content has been drafted or imported, locations for signatures can be added at desired locations. A user can add one or more names 108 to the signer list module of person(s) that will sign the document. The names can represent persons, or entity's represented by persons, that will sign the document. The person(s) that will sign the document are referred to as signing individuals. A function 110 of each signing individual can be associated with the individual's name. For example, their function relative to the document may be a buyer, a seller, an assignee, an assignor, a notary, a witness, and so forth. An example user interface 120 for entering a signing individual's name in the signer list module is shown in FIG. 1b. The function associated with the signing individual can also be entered. A notary checkbox 122 can be selected in the user interface to designate the signing individual as a notary, as will be discussed more fully below.

A person or entity added to the placeholder electronic document in the signer list module can be edited. An example edit person user interface 150 for editing a name is shown in FIG. 1c. The edit person user interface can allow the name 108 and function 110 of each person or entity listed in the signer list module 106 (FIG. 1a) to be changed in the placeholder electronic document. In one embodiment, the signer list module 106 can verify that no duplicate names are added to the list, either initially or when editing the names. In another embodiment, the function of notary cannot be edited after a signing individual is designated as a notary. The checkbox in FIG. 1b can be automatically deactivated. The designated notary can only be deleted. In yet another embodiment, the function of notary can be actively edited and changed using the edit person user interface in the editing module 102 (FIG. 1a).

A tagging module 202, as shown in FIG. 2, can be included in or coupled to the editing module 102. For example, FIG. 2 shows one embodiment of the editing module containing a viewing pane for the text editing area 104 configured to display content 204 to be attested to with a signature. In one embodiment, a cursor can be placed at a location where a signature will be placed within the document. A signing individual in the signer list module 106 can be selected. A signature tag 206 can be placed within the document at a desired location where the cursor has been located. In another embodiment, the signature tag can be dragged and dropped to a desired location within the document.

Each signature tag 206 can have at least three types of information associated with the tag. In one embodiment, each tag can have a tag ID, a tag type, and a tag state. The tag ID can be a unique numerical number to distinguish each tag from other tags in the document. The tag having the lowest numerical number can be selected from a pool of tags. If a tag is deleted, the tag's associated ID can be returned to the pool to be reused. Any type of tag identification system can be used that allows the signature tags in the document to be uniquely identified by a computer.

The type of signature tag 206 that is placed in the placeholder electronic document can be selected using the tagging module 202. For example, FIG. 2 shows a signature button selected in the tagging module. Selecting the signature button will place a full signature tag at the selected location within the placeholder electronic document, providing a location for the signing individual to write their signature, as will be described more fully below. It is also possible to select an initial tag and a notary tag using the tagging module. The type of tags that can be selected may be dependent on a function of the selected signing individual.

The function 110 of the signing individual selected in the signer list module 106 can affect the types of tags that can be selected in the tagging module 202. In the example shown in FIG. 2, the signing individual is listed as a buyer. After selecting the signing individual, a signature tag 206 can be placed in the document by selecting the signature button for a full signature tag or the initial button for an initial tag. The notary tag is deactivated since the signing individual is not a notary. Conversely, if the signing individual has been designated with a function type of notary, the notary button can be selected and the initial and signature buttons can be automatically deactivated. Other types of tags can also be assigned to specific functions as desired.

Each signature tag 206 can also include information about a state of the tag. For example, the state may be signed or unsigned. The editing module 102 can include a tag navigation module 208. The tag navigation module can enable a user, such as a document preparer, to quickly view the tags within the document shown in the editing module 102 that are associated with a selected signing individual. For example, John Hancock can be selected in the signer list module 106. The Next button in the tag navigation module 208 can be selected to allow a user to view subsequent signature tags in the document that are associated with John Hancock. The user can also view previous tags by selecting the Previous button and can delete unwanted tags by selecting the Delete button.

The placeholder electronic document can be saved at any time. The document can be saved in a proprietary format that stores the document content with the information in the signer list module 106, as well as the location of and information associated with each signature tag. Once the placeholder electronic document is completed, with acceptable content 204 and the desired signature tags 206 placed within the document, a secure document creation module 210 enables the placeholder electronic document to be saved into a secure electronic document format. In one embodiment, this can be accomplished by selecting the Create *.sdoc button in the secure document creation module. Selecting this button will convert the placeholder electronic document into a secure format to form a secure electronic document.

The secure electronic document is configured to make the content of the placeholder electronic document uneditable. Content cannot be changed or removed. Signature tags and their associated information can also not be changed or removed. Thus, the secure electronic document provides an electronic form in which a document can be sent without concern for changes being made in the content or signature information.

The secure electronic document can be transmitted to one or more persons on the signer list module 106 to enable them to sign the document. The secure electronic document can be transmitted using known means, such as e-mail, file transfer protocol, and the like. Alternatively, the secure electronic document can be placed on a web server and accessed over the internet. For example, the secure electronic document may be accessed using hyper text transfer protocol (HTTP) or secure HTTP.

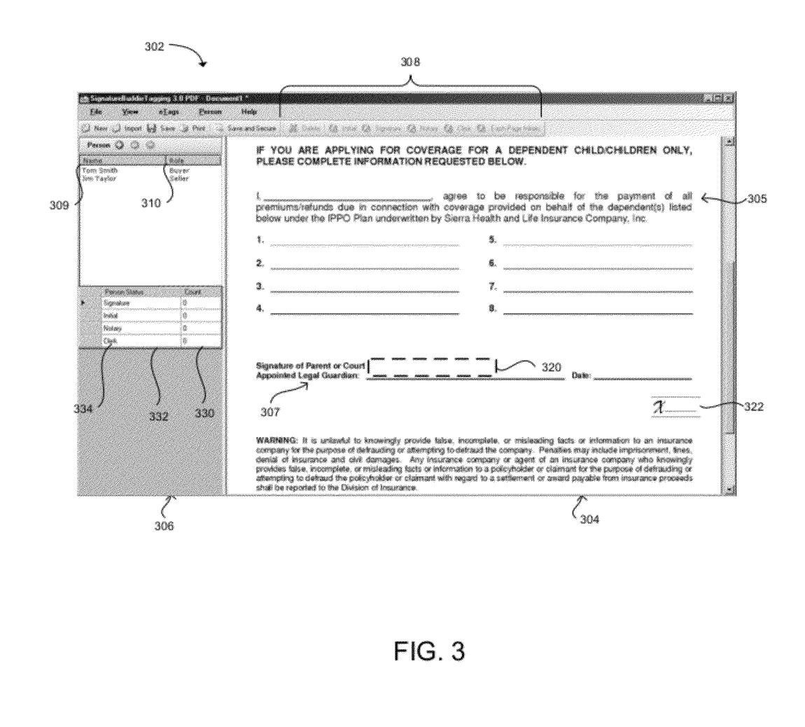

A secure document signer module can be used to view the secure electronic document and the signature tags. The secure document signer module is configured to accept written signatures from the signing individuals at the signature tag location. An example embodiment of a secure document signer module 302 is shown in FIG. 3. The secure document signer module can be configured to have a similar appearance to the editing module 102. The similar appearance between the editing module and the secure document signer module can increase usability of the software. The secure document signer module can include a viewing pane 304. A signer list module 306 can be included in or coupled to the secure document signer module.

A user can open a secure electronic document that was previously created using the editing module 102 (FIGS. 1, 2) using the secure document signer module 302. The secure document signer module can display the content 305 and signature tag(s) 307. A signature capture module 308 can be included in or coupled to the secure document signer module. The signature capture module can be used in conjunction with a signature capture device to enable signing individuals to embed their written signature into the secure electronic document.

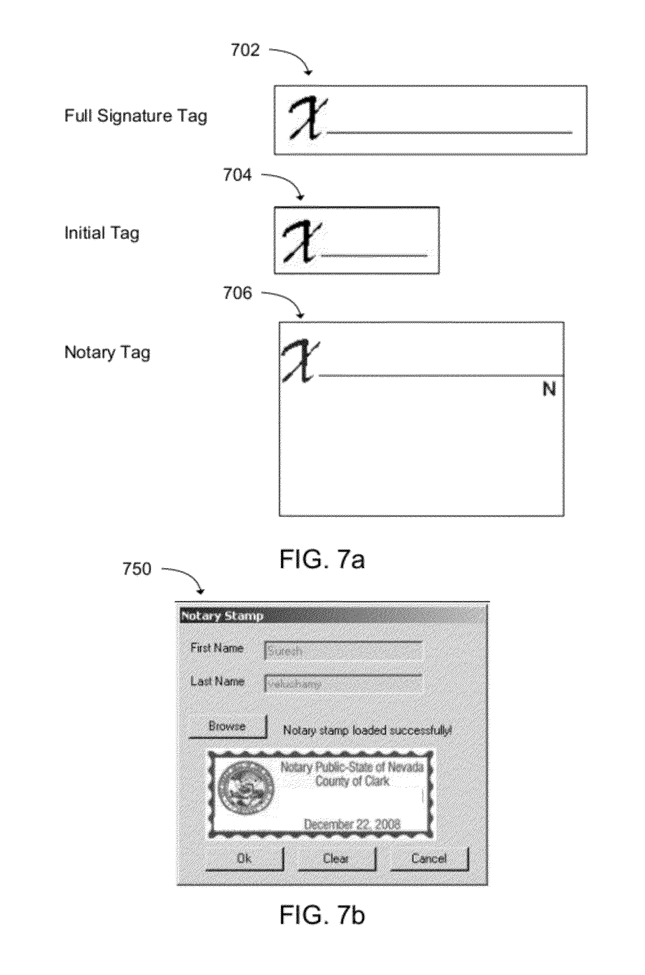

For instance, a signing individual listed in the signer list module 306 can select his or her name 309. The signing individual can then select the Sign button in the signature capture module 308. The signature capture module can be configured to communicate with a signature capture device. Activating the signature capture module can cause a first signature tag associated with the selected signing individual to be highlighted. The appearance of the signature tag can inform the signing individual what type of signature is needed at the highlighted signature tag. For example, the signature tag may be a full signature tag 702, an initial tag 704, or a notary tag 706, as shown in FIG. 7a. The signing individual can write the appropriate signature or initials corresponding with the highlighted tag using the signature capture device.

Referring again to FIG. 3, a signature bounding box 320 associated with the signature tag can be resized to fit in a signature area of the placeholder electronic document. The signature bounding box can be automatically resized to fit a signature captured by the signature capture device. Alternatively, the signature bounding box can be resized by an administrator who is creating a placeholder electronic document to fit a signature to be captured by the signature capture device. A date and time can also be embedded into the signature bounding box in the placeholder electronic document. This date and time may be hidden and embedded with the signature bounding box, or the date and time may be viewable when a user interface action is taken to view the date (e.g., a cursor is moved over the box and a popup appears to show the date). The reference here to a signature bounding box being resizable also applies to initial tags that can be applied to placeholder electronic document.

In one embodiment, the ability to physically size the signature bounding boxes and initial bounding boxes on the electronic document means that the box on the signature capture device (LED screen) may be fixed in size, if desired. For example, the signature capture device box can have one size for a signature and one size for a signers initials. In this situation, if the size of the bounding box is changed on the electronic document to fit an area on the document, the size of signature bounding box may not change on the signature capture device.

Initial tags 322 can also be placed in a lower corner of each page of the placeholder electronic document into which initials of a signing individual are captured. The initials on multiple pages can be placed with a single user action of placing one initial tag that will copy a tag to every page. In other words, automatic initial tagging of all the pages can take place with a single click of a mouse button. For example, a 50 page document can be initialed in one operation instead of dragging and dropping an initials tag on all 50 pages.

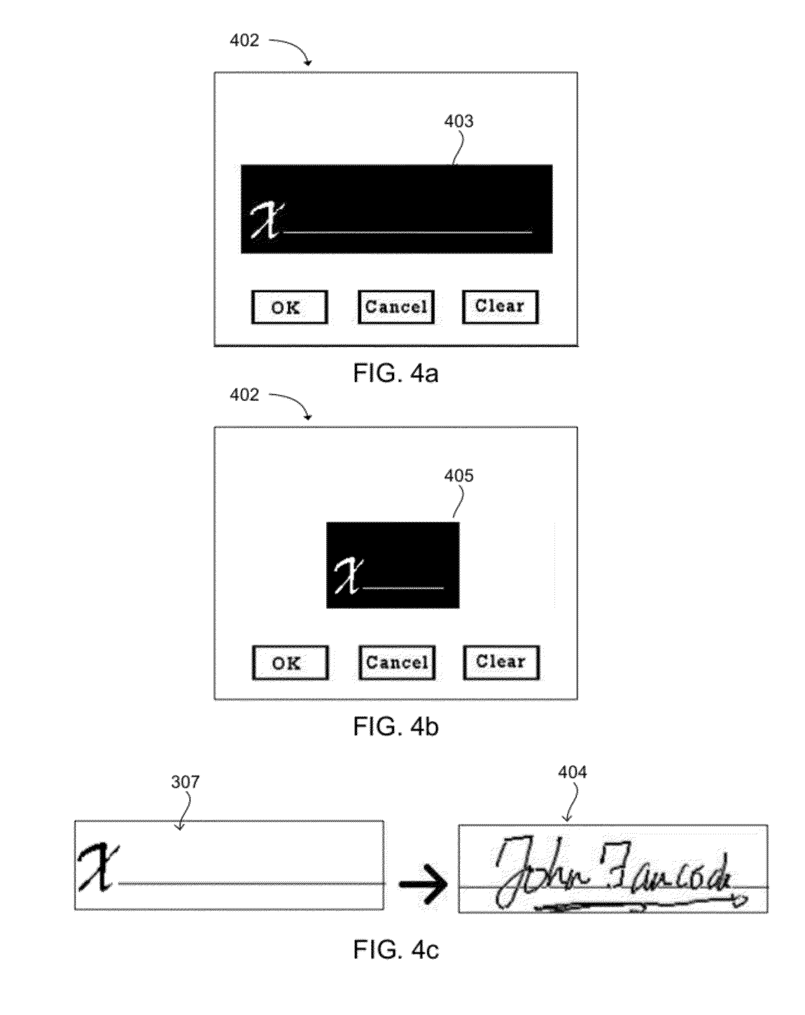

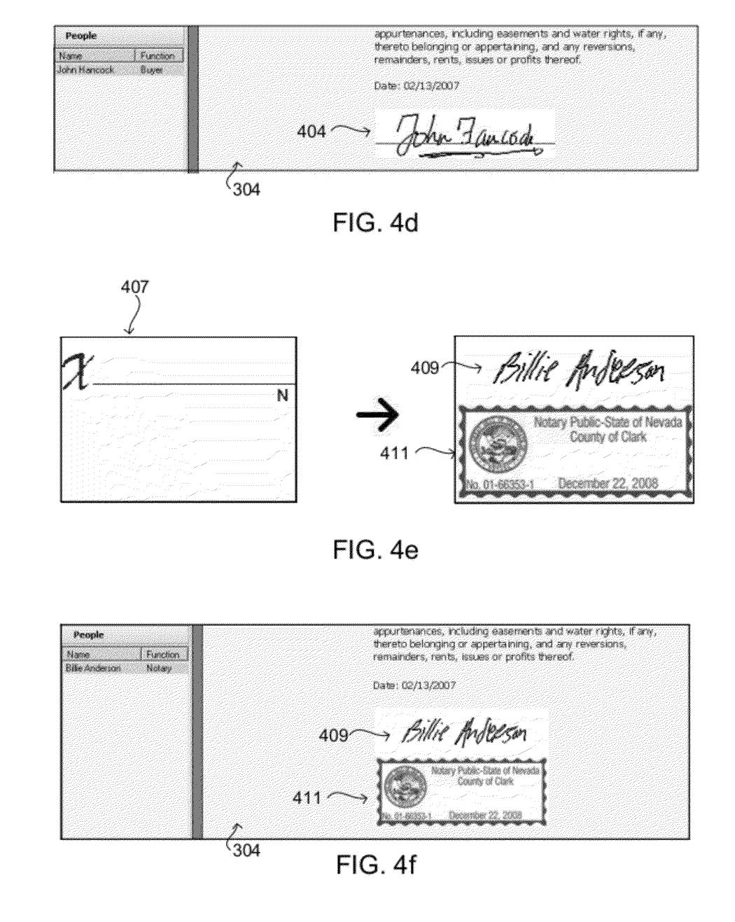

An auto counter 330 can be associated with each signing individual 334 to indicate a number of remaining signatures desired from each signing individual. For example, one signer may sign in 5 locations and believe the signing is complete. However, the counter may indicate that one or two signature locations have been missed and need to be completed. This aids users in making sure that a document is complete. This type of counter or reporting can apply to each user in the system. In addition, a drag and drop function can be used to create the formatted signature box by dragging a person's name from a person list 332 to the document. FIGS. 4a-4d illustrate an example embodiment for embedding a signature into the secure electronic document. After selecting a signing individual in the signer list module and selecting the Sign button in the signature capture module, the signing individual can write his or her signature in the signature capture device 402, as shown in FIGS. 4a and 4b. In one embodiment, the signature capture module can communicate with the signature capture device. The signature capture device can display a capture bounding box that is sized according to the type of signature designated by the signature tag. For example, FIG. 4a displays a signature bounding box 403. In another example, FIG. 4b displays the signature capture device with an initial bounding box 405. After writing a desired signature or initials in the bounding box 403, 405, the signing individual can select OK, enabling the written signature or initials to be electronically transmitted to the signature capture module in a digitized format.

FIG. 4c demonstrates one embodiment in which the signature capture module can then communicate with the secure document signer module to replace the signature tag 307 with an embedded signature 404 at the signature tag location. FIG. 4d shows the embedded signature 404, as displayed in the viewing pane 304, which has been inserted into the secure electronic document in place of the signature tag.

The signature tag 307 and the embedded signature 404 can have a substantially similar size to the signature bounding boxes 403, 405 shown in FIGS. 4a and 4b. The substantially similar size of the signature tag, bounding box, and embedded signature can enable the handwritten signatures that are entered using the signature capture device 402 to be embedded in the secure electronic document in a near original size. The similar sizes can also prevent deformation of the signature due to changes in the dimension of the embedded signature image. If a change in size of the embedded signature is needed for a specific type of document, the embedded signature size can be changed proportionally with respect to the height and width to minimize any deformation of the original signature.

FIG. 4e demonstrates one embodiment in which the signature capture module can communicate with the secure document signer module to replace a notary tag 407 with an embedded notary signature 409 and a notary stamp 411 corresponding with the embedded signature of the notary, as previously described. FIG. 4f shows the embedded notary signature 409 and associated signature tag 411, as displayed in the viewing pane 304, which has been inserted into the secure electronic document in place of the notary tag.

The signature capture device 402, as shown in FIG. 4a, can be any type of electronic signature capture device capable of communicating with a computer. Alternatively, the signature capture device can be built in to a computer, such as a touch screen or tablet type computer. The signature capture device can be configured to remotely communicate with the signature capture module and/or the secure electronic document signer module. The communication means can include communication through a local area network, a wide area network, an internet connection, a wireless connection, a wired connection including a USB connection, a telephone connection, and a broadband connection.

Returning to FIG. 3, an auto scrolling module can be coupled to the secure document signer module 302. The auto scrolling module can be embedded with the signature capture module 308. The auto scrolling module can allow the secure document signer module to automatically scroll from a first signature tag related to a signing individual to a next signature tag related to the signing individual after the signing individual's signature is embedded at a location of the first signature tag in the secure electronic document displayed in the viewing pane 304. The auto scrolling module can know the state of the tag (signed or unsigned) to enable a signing individual to automatically scroll to a next unsigned signature tag associated with the signing individual.

A tag navigation module can allow the signing individual to manually navigate through the document to view the locations for his or her signature. Tag navigation can be accomplished, for example, by selecting one of the next and previous buttons available in the signature capture module 308. Selecting one of the next and previous buttons will allow a user to view the signature tags or embedded signatures associated with the person 309 selected in the signer list module 306.

In one embodiment, the secure document signer module 302 can provide a secure sign-in procedure to provide security such that a signing individual can only sign at signature tags 307 associated with the signing individual. For example, when a signing individual receives a secure electronic document, they can open the document with the secure document signer module. In order for the signing individual to select their name 309 from the signer list module 306, they can enter a predetermined password in a password user interface. Alternatively, the password user interface may be activated when a user selects a signing individual in the signer list module. Password protection can provide an additional level of security to the secure electronic document to ensure that each embedded signature is authentic.

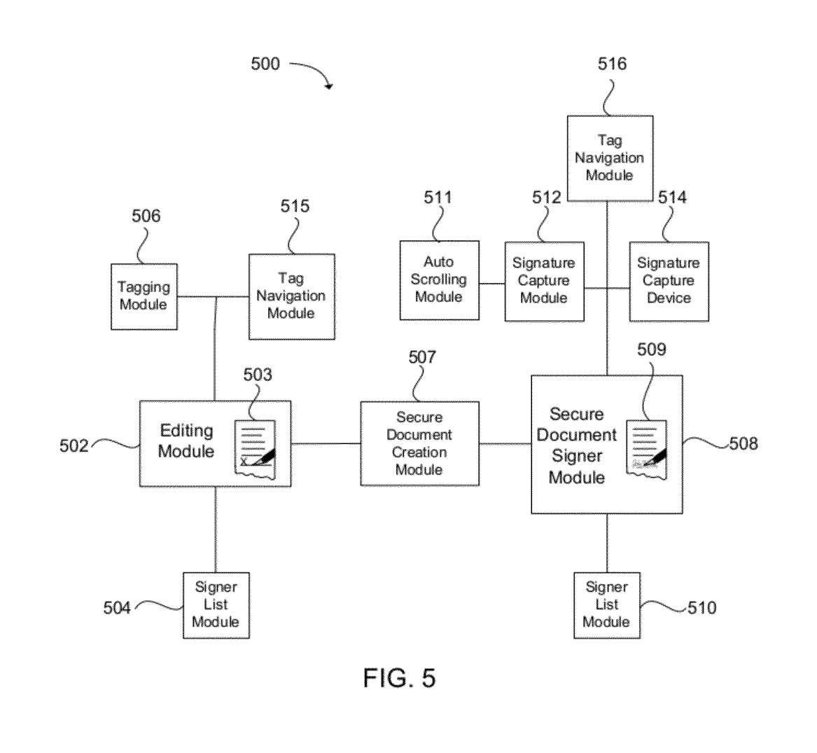

The user interfaces, as illustrated and previously described, represent specific embodiments of the systems and methods disclosed. Of course, a wide variety of different types of user interfaces are possible. FIG. 5 illustrates a more generalized view of a system 500 for embedding a signature into a secure electronic document. The system includes an editing module 502 configured to edit content in an editable document 503. The grammatical and/or illustrative content that is drafted or imported into the editing module can be attested to by a signature. A signer list module 504 is coupled to the editing module. A user can enter one or more persons or entities into the signer list module that will attest to the content in the document with a signature. A tagging module 506 provides signature tags that can be placed in the document at a desired location for a signature. Each tag is associated with a person or entity in the signer list module. The tags can also be associated with additional information, such as a unique identifier number, a tag type, and a signing status, as previously discussed. Different types of signature tags can be placed in the document, including an initial tag, a full signature tag, and a notary tag. A tag navigation module 515 can be used to navigate between signature tags associated with a selected signing individual by selecting one of a Next and a Previous button.

The editable document 503 containing signature tags can be saved in a proprietary format as a placeholder electronic document. The placeholder electronic document is fully editable, allowing changes in the content as well as the location and type of signature tags in the document. Persons or entities placed in the signer list module 504 can also be edited or removed. When the document is in a final form ready for signing then the document can be converted into a secure electronic document through the secure document creation module 507 to form a secure electronic document 509.

The secure electronic document 509 can be opened in a secure document signer module 508. Once the document is converted into a secure form then no content changes are allowed. The persons and entities listed in the signer list module 510 can not be edited or removed. The location and types of signature tags in the secure electronic document are also uneditable. The only alteration that can be made in the secure electronic document is for the persons or entities listed in the signer list module 510 to embed their written signature into the secure electronic document 509 at signature tag locations associated with the person or entity.

The signature tag type can be communicated to the signature capture device 514 from the signature capture module 512 or secure document signer module 508. As previously discussed, the signature capture device can be configured to display an appropriately sized bounding box based on the type of signature tag. For example, one size of bounding box may be displayed in the signature capture device when a full signature is needed. A different sized bounding box can be displayed when initials are needed in the secure electronic document 509. Having a bounding box with a similar size to the signature tag and/or embedded signature enables a life sized embedded signature to be displayed. If a change in size of embedded signature is needed for a specific type of document, the embedded signature size will typically be changed proportionally with respect to the height and width to minimize any deformation of the original signature.

A signing individual can select themselves or the entity that they represent in the signer list module 510 and activate the signature capture module 512. The signing individual can then use a signature capture device 514 coupled to the signature capture module and/or the secure document signer module 508 to write their signature. The signature can then be embedded at a signature tag location as previously discussed. Each signature tag location can require a separate signature or initial. A single signature is typically not copied to multiple signature tag locations. Once a signature has been embedded, an auto scrolling module 511 can automatically scroll to a next signature tag associated with the selected signing individual. A tag navigation module 516 can also be used to manually navigate between signature tags associated with a selected signing individual. For example, the tag navigation module can enable manual viewing of embedded signatures or signature tags associated with a selected signing individual by selecting one of a Next and a Previous button. Other types of graphical user interfaces can also be used to allow the manual viewing of signatures and signature tags associated with each signing individual.

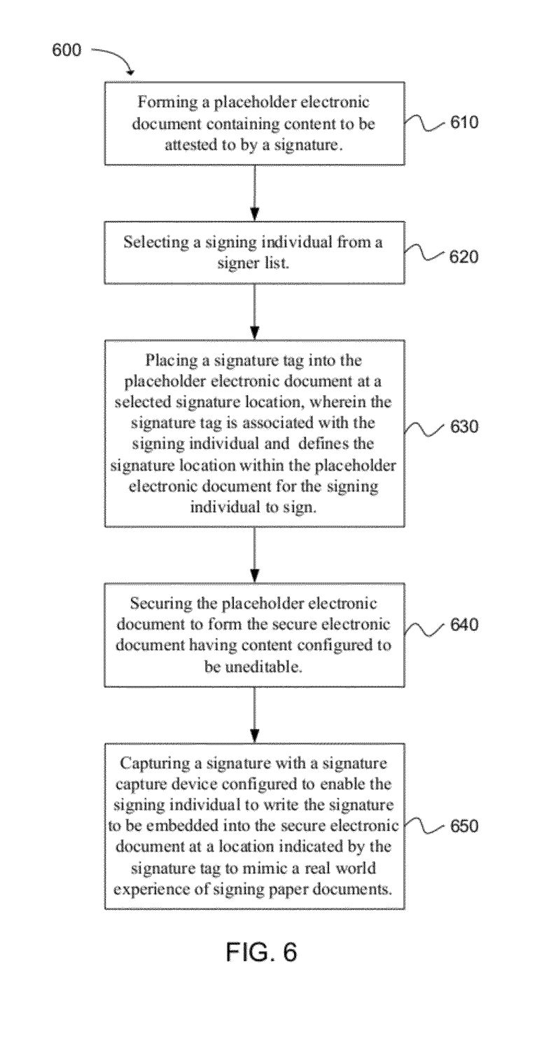

Another embodiment of the invention provides a method 600 for embedding a written signature into a secure electronic document, as illustrated in the flow chart in FIG. 6. The method includes the operation of forming 610 a placeholder electronic document containing content to be attested to by a signature. A further operation involves selecting 620 a signing individual from a signer list. Another operation includes placing 630 a signature tag into the placeholder electronic document at a selected signature location, wherein the signature tag is associated with the signing individual and defines the signature location within the placeholder electronic document for the signing individual to sign.

A further operation involves securing 640 the placeholder electronic document to form the secure electronic document having content configured to be uneditable. Another operation provides capturing 650 a signature with a signature capture device configured to enable the signing individual to write the signature to be embedded into the secure electronic document at a location indicated by the signature tag to mimic a real world experience of signing paper documents. The signature can be captured and embedded into the secure electronic document in real time, at a time the signing transaction takes place.

A plurality of signing individuals can be added to the signer list. Each signature tag can be associated with an individual or entity in the signer list. Each signing individual in the signer list can be associated with a function, such as buyer, seller, and notary. Some functions may be given different rights than other functions. For example, a notary may be allowed to insert a notary stamp along with the notary's signature. The notary's signature and stamp may be inserted into the secure electronic document as separate embedded items. Alternatively, the signature and stamp may be inserted as a single embedded item or electronic image.

Several different types of signature tags can be placed in the placeholder electronic document, including a full signature tag 702, an initial tag 704 and a notary tag 706, as shown in FIG. 7a. Each tag can have a unique appearance allowing a user to discern what type of signature is to be written at each location in the document. Each signature tag can be selected from a pool of signature tags having unique identification. Once the signature tag is placed in the document, the tag can also be associated with information related to a status of the tag, such as signed or unsigned.

The notary tag can have a larger space set aside to enable the notary's signature and stamp to be placed in the notary tag area. In one embodiment, as shown in FIG. 7b, a notary stamp user interface 750 can be used that enables a notary to load a digitized version of their notary stamp. The notary stamp can be associated with the notary's signature and embedded in the secure electronic document at the location of the notary's tag, as previously discussed.

The secure electronic document can be saved with one or more embedded signatures. The captured signatures themselves are typically not saved. Thus, in order for each signature to be embedded within the secure electronic document at a signature tag location, a signing individual must write their signature using a signature capture device. In one embodiment, a secure electronic document can be sent in series to each person or entity listed in the signer list. After a first individual on the signer list completes signing the secure electronic document, the document can be saved and sent to the next person or entity on the signer list, and so forth until each person on the signer list has completed signing the document. This allows multiple people in locations remote from one another to sign the secure electronic document without the need for each signing individual to travel to a single location.

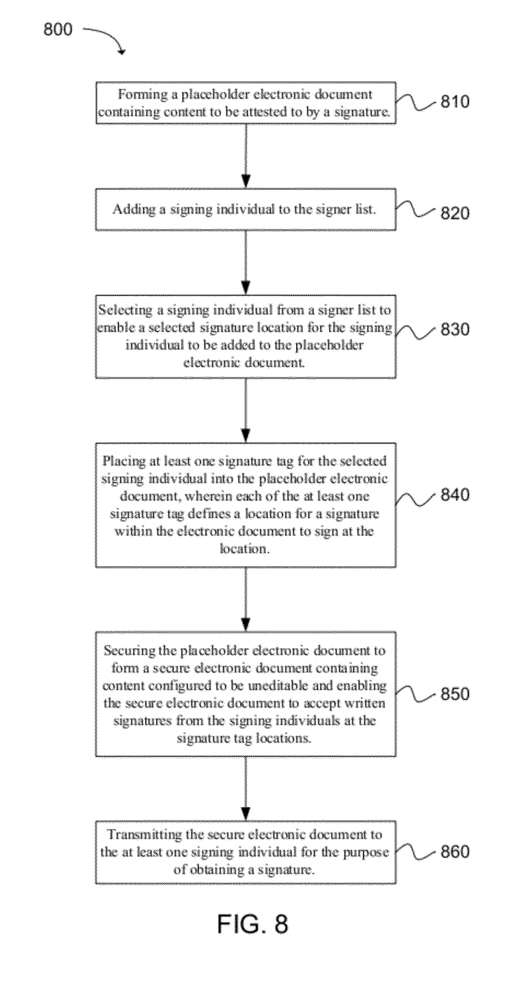

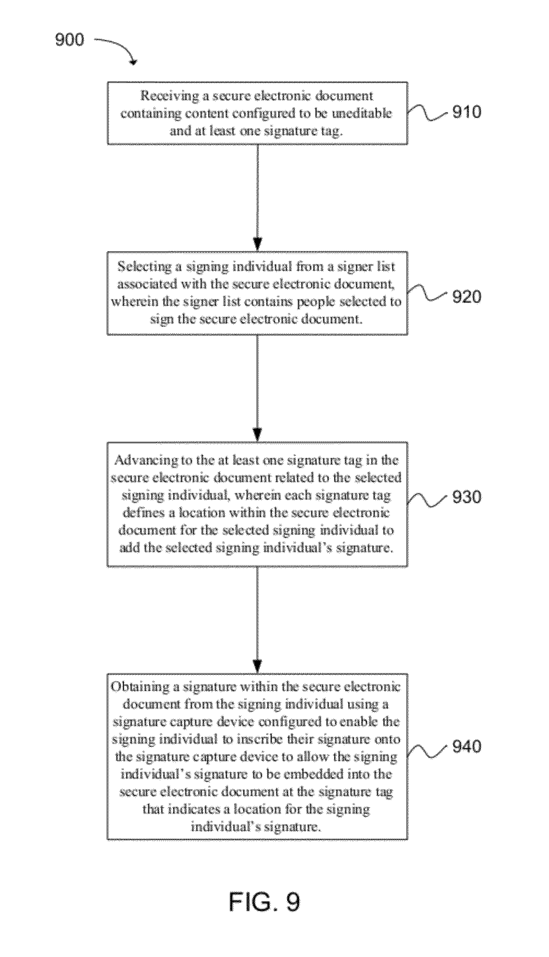

In another embodiment, a method 800 for transmitting an electronic document for embedding a written signature is disclosed, as shown in the flow chart in FIG. 8. The method enables a user to prepare a placeholder electronic document having a one or more signature tags and transmit the secure electronic document to a signing individual to obtain their signature. The method includes the operation of forming 810 a placeholder electronic document containing content to be attested to by a signature. An additional operation includes adding 820 a signing individual to the signer list. A further operation provides selecting 830 a signing individual from a signer list to enable a selected signature location for the signing individual to be added to the placeholder electronic document.

The method 800 additionally includes placing 840 at least one signature tag for the selected signing individual into the placeholder electronic document, wherein each of the at least one signature tag defines a location for a signature within the electronic document to sign at the location. An additional operation provides securing 850 the placeholder electronic document to form a secure electronic document containing content configured to be uneditable and enabling the secure electronic document to accept written signatures from the signing individuals at the signature tag locations. A further operation provides transmitting 860 the secure electronic document to the at least one signing individual for the purpose of obtaining a signature.

The user that transmits the secure electronic document can obtain a signature within the secure electronic document from the at least one signing individual using a signature capture device configured to enable the signing individual to inscribe their signature onto the signature capture device to allow the signing individual's signature to be embedded into the secure electronic document at the signature tag that indicates a location for the signing individual's signature.

A method 900 is disclosed for receiving an electronic document for embedding a written signature. For example, a signing individual may receive a secure electronic document having at least one signature tag. The signing individual may embed their signature at the at least one signature tag and return the document to the sender, or send the document for additional signatures.

The method 900 includes the operation of receiving 910 a secure electronic document containing content configured to be uneditable and at least one signature tag. An additional operation provides selecting 920 a signing individual from a signer list associated with the secure electronic document, wherein the signer list contains people selected to sign the secure electronic document. Another operation includes advancing 930 to the at least one signature tag in the secure electronic document related to the selected signing individual, wherein each signature tag defines a location within the secure electronic document for the selected signing individual to add the selected signing individual's signature.

The method further includes the operation of obtaining 940 a signature within the secure electronic document from the signing individual using a signature capture device configured to enable the signing individual to inscribe their signature onto the signature capture device to allow the signing individual's signature to be embedded into the secure electronic document at the signature tag that indicates a location for the signing individual's signature.

The system and methods disclosed provide a simple, user friendly process for embedding a written signature into a secure electronic document. The process does not require any complex codes and numbers instituted in many government, legal, and industry group standards for electronic signatures. While the codes and numbers may provide a level of security, the visual information provided by a written signature is eliminated. Parties to a signatory document have historically relied on the visual information provided by a simple signature. The system and methods disclosed in the recited claims allows the unique benefits of a written signature to be retained. Thus, the process disclosed preserves centuries of legal and business precedent while enabling signed documents to be simply and easily electronically transmitted between remote locations.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for embedding a written signature into a secure electronic document, comprising:
forming a placeholder electronic document containing content to be attested to by a signature;
selecting a signing individual from a signer list;
placing a signature tag into the placeholder electronic document at a selected signature location, wherein the signature tag is associated with the signing individual and defines the signature location within the placeholder electronic document for the signing individual to sign;
securing the placeholder electronic document to form the secure electronic document having content configured to be uneditable; and
capturing a signature with a signature capture device configured to enable the signing individual to write the signature to be embedded into the secure electronic document at a location indicated by the signature tag to mimic a real world experience of signing paper documents;
enabling a signature bounding box associated with the signature tag to be resized to fit in a signature area of the placeholder electronic document.

2. A method as in claim 1, further comprising enabling the signature bounding box to be automatically resized to fit a signature captured by the signature capture device.

3. A method as in claim 1, further comprising enabling the signature bounding box to be resized by an end user to fit a signature captured by the signature capture device.

4. A method as in claim 3, further comprising embedding a date and time into the signature bounding box in the placeholder electronic document.

5. A method as in claim 1, further comprising adding a plurality of signing individuals to the signer list to enable the signature tag to be associated with one of the plurality of signing individuals.

6. A method as in claim 5, further comprising placing a unique signature tag associated with the selected signing individual from the plurality of signing individuals at every location throughout the placeholder electronic document where the signing individual will sign.

7. A method as in claim 1, further comprising placing initial tags in a lower corner of each page of the placeholder electronic document into which initials of a signing individual are captured.

8. A method as in claim 5, further comprising providing an auto counter associated with each signing individual to indicate a number of remaining signatures desired from each signing individual.

9. A method as in claim 1, further comprising configuring the secure electronic document such that the embedded signature can be saved in the secure electronic document.

10. A method as in claim 1, wherein capturing a signature further comprises capturing a signature at a time a transaction takes place.

11. A method as in claim 1, further comprising enabling a drag and drop function to create the formatted signature box by dragging a person's name from the person list to the document.

12. A system for embedding a written signature into a secure electronic document, comprising:
an editing module configured to edit content in a placeholder electronic document, wherein the content is to be attested to by a signature;
a signer list module comprising a list of selectable signing individuals;
a tagging module for adding at least one signature tag associated with the selected signing individual to the placeholder electronic document, wherein each of the at least one signature tag defines a location for a signature within the electronic document and indicates the signing individual associated with the signature tag to sign at the location, wherein a signature bounding box is associated with the signature tag and is resizable to fit in a signature area of the placeholder electronic document;
a secure document creation module for securing the content in the placeholder electronic document to form a secure electronic document containing content configured to be uneditable;
a secure document signer module to enable the secure electronic document to be viewed and to accept written signatures from the signing individuals at the signature tag location;
a signature capture device configured to enable the signing individual to write a signature at a transaction time for each of the at least one signature tag associated with the signing individual; and
a signature capture module configured to electronically embed the signature of the signing individual from the signature capture device into the secure electronic document at a location of each of the at least one signature tag associated with the signing individual.

13. A system as in claim 12, further comprising further comprising providing an auto counter associated with each signing individual to indicate a number of remaining signatures desired from a signing individual.

14. A system as in claim 12, further comprising a drag and drop module to create the formatted signature box by dragging a person's name from a person list to the document

15. A method for transmitting an electronic document for embedding a written signature, comprising:
forming a placeholder electronic document containing content to be attested to by a signature;
adding a signing individual to the signer list;
selecting a signing individual from a signer list to enable a selected signature location for the signing individual to be added to the placeholder electronic document;
placing at least one signature tag for the selected signing individual into the placeholder electronic document, wherein each of the at least one signature tag defines a location for a signature within the electronic document to sign at the location;
securing the placeholder electronic document to form a secure electronic document containing content configured to be uneditable and enabling the secure electronic document to accept written signatures from the signing individuals at the signature tag locations; and
transmitting the secure electronic document to the at least one signing individual for the purpose of obtaining a signature.

16. A method as in claim 15, further comprising obtaining a signature within the secure electronic document from the at least one signing individual using a signature capture device configured to enable the signing individual to inscribe their signature onto the signature capture device to allow the signing individual's signature to be embedded into the secure electronic document at the signature tag that indicates a location for the signing individual's signature.

17. A method for receiving an electronic document for embedding a written signature, comprising:
receiving a secure electronic document containing content configured to be uneditable and at least one signature tag;
selecting a signing individual from a signer list associated with the secure electronic document, wherein the signer list contains people selected to sign the secure electronic document;
advancing to the at least one signature tag in the secure electronic document related to the selected signing individual, wherein each signature tag defines a location within the electronic document for the selected signing individual to add the selected signing individual's signature; and
obtaining a signature within the secure electronic document from the signing individual using a signature capture device configured to enable the signing individual to inscribe their signature onto the signature capture device to allow the signing individual's signature to be embedded into the secure electronic document at the signature tag that indicates a location for the signing individual's signature;
enabling a signature bounding box associated with the signature tag to be resized to fit in a signature area of the placeholder electronic document.
